(19) United States
(12) Patent Application Publication
(10) Pub. No.: US 2018/0343790 A1
(43) Pub. Date: Dec. 6, 2018

(54) Fertilizer Application System Using Multiple Longitudinal Distributors

(71) Applicant: CNH Industrial Canada, Ltd., Saskatoon (CA)

(72) Inventors: Martin J. Roberge, Saskatoon (CA); Joel Denis, Saskatoon (CA); Rex L. Ruppert, Benson, MN (US)

(21) Appl. No.: 15/613,849

(22) Filed: Jun. 5, 2017

(51) Int. Cl. A01C 15/00; A01C 19/02; A01C 15/14

(52) U.S. Cl. CPC A01C 15/006; A01C 19/02; A01C 15/005; A01C 15/00; A01C 15/14

(57) ABSTRACT

The present invention is directed to an applicator having an agricultural product mechanical conveying system which transfers particulate material metered into the mechanical conveying system from one or more source containers to the application equipment on demand, and meters the material at the application equipment. The mechanical conveying system employs longitudinal mechanical distributors that operate to move and mix the particulate material from one of the source containers or tanks along the mechanical distributor to a plenum. At the plenum the different types of particulate materials are further blended, such as within a particle injector, and delivered to the distribution nozzles for discharge from the applicator.

### FIELD OF THE DISCLOSURE

The present invention relates generally to agricultural equipment, and, more particularly, to an agricultural product delivery system on an application implement, such as a planter or fertilizer application equipment, for applying particulate material such as seed, fertilizer, herbicide or insecticide in a field, either as a surface application or deposited in the soil to improve soil quality.

### BACKGROUND OF THE DISCLOSURE

Agricultural product delivery systems are known to utilize various mechanisms, including mechanical and pneumatic systems, i.e., a flow of an to assist in the delivery and movement of particulate material or product such as fertilizer, seed, insecticide or herbicide from a product supply chamber through an interior passage provided by a series of elongate tubes which extend from the product supply chamber to a product applicator that places the product on or in growing medium, such as soil. Such agricultural product delivery systems are commonly employed in planters, air drills fertilizer and pesticide applicators and a variety of other agricultural, implements.

Agricultural implements that employ an agricultural product delivery system are known to have a particulate material supply source such as one or more tanks that are loaded with the particulate material or materials to be applied. The tanks have or are associated with a metering device, which typically consists of a rotating element, which meters the particulate materials from the tanks into a set of distribution channels, such as conduits, hoses, etc., for application to the farm field. In most systems, a pneumatic source such as a fan or blower provides air to convey and distribute material through the distribution channels. Once the metering of particulates is done and the mix of an and particulates is in the distribution channels, the solid concentration should remain nearly constant and in dilute, phase.

Systems as described have provided certain advantages and have worked at in some aspects, but are not without disadvantages, inefficiencies or inconveniences. For example, it is desirable to use a material supply source, such as a tank, with different applicator equipment by, for example, coupling the tanks with a planter for planting seed, and later coupling the same tank equipment with an applicator for applying needed pesticides and/or fertilizer. This has been difficult due to the necessary metering systems for applying the different materials. With the metering device provided on the tank, it is necessary to adjust the metering device whenever the tank is used for supplying a different material. This can be time consuming and inconvenient if the metering device is underneath the tank.

While the use of a metering system can effectively distribute the different particulate material to the various distribution channels and nozzles of the applicator, the metering system itself is a complex mechanism that must be accurately operated in order to effectively distribute the particulate matter to each nozzle and to accommodate for operational changes including additional particulate material(s) to be dispensed and turning compensations, among others

What is needed in the art is an agricultural product conveying system which improves efficiency and convenience of the applicator without further complicating its construction.

### SUMMARY OF THE DISCLOSURE

According to one aspect of the present disclosure, an applicator includes an agricultural product mechanical conveying system which transfers particulate material from one or more source containers to application equipment on demand, and meters the material at the application equipment. The mechanical conveying system employs longitudinal mechanical distributors that operate to move, mix and meter the particulate material from one of the source containers or tanks along the mechanical distributor to a plenum. At the plenum the different types of particulate materials are further blended, such as within a particle injector, and delivered to the distribution nozzles for discharge from the applicator. The mechanical conveying system has a simplified construction and operation in comparison to prior art systems.

According to another aspect of the present disclosure, the mechanical conveying system can be configured to minimize the distance between the tanks or source containers and the particle injectors at one or both of the front and rear of the applicator to mix the various particulate material(s) with one another as the material is moved towards the plenums, thus negating the need for a separate mixing or metering system.

According to another aspect of the invention, an agricultural product delivery system includes at least one particulate material supply compartment, at least one particle delivery unit for applying particulate material from the supply compartment and a mechanical conveying system providing a metered flow of particulate material from the at least one particulate material supply compartment to the at least one particle delivery unit.

According to a further aspect of the present invention, a method of delivering a number of agricultural products from a number of compartment containing the number of products to a particle delivering unit applying the particles in a field includes the steps of supplying the number of agricultural products from the number of compartments to a mechanical conveying system, mixing the agricultural product in the mechanical conveying system to form a mixed product; conveying the mixed product to the particle delivering unit; metering the mixed product within the mechanical conveying system; and applying the mixed product in an agricultural field.

Numerous additional objects, aspects and advantages of the present invention will be made apparent from the following detailed description taken together with the drawing figures.

### BRIEF DESCRIPTION OF THE DRAWINGS

The drawings illustrate the best mode of practicing the present disclosure.

In the drawings:

FIG. 1 is a perspective view of an agricultural application implement, in the nature of a fertilizer spreader, having a mechanical conveying system according to one exemplary embodiment of the invention.

FIG. 2 top view of the fertilizer spreader shown in FIG. 1

FIG. 3 is an isometric view of the tank and mechanical conveying system according another exemplary embodiment of the invention.

FIG. 4 is a top view in schematic form of a mechanical conveying system on a fertilizer spreader according to another exemplary embodiment of the invention.

FIG. 5 is a side plan view of the tank and mechanical conveying system of FIG. 3.

### DETAILED DESCRIPTION OF THE DISCLOSURE

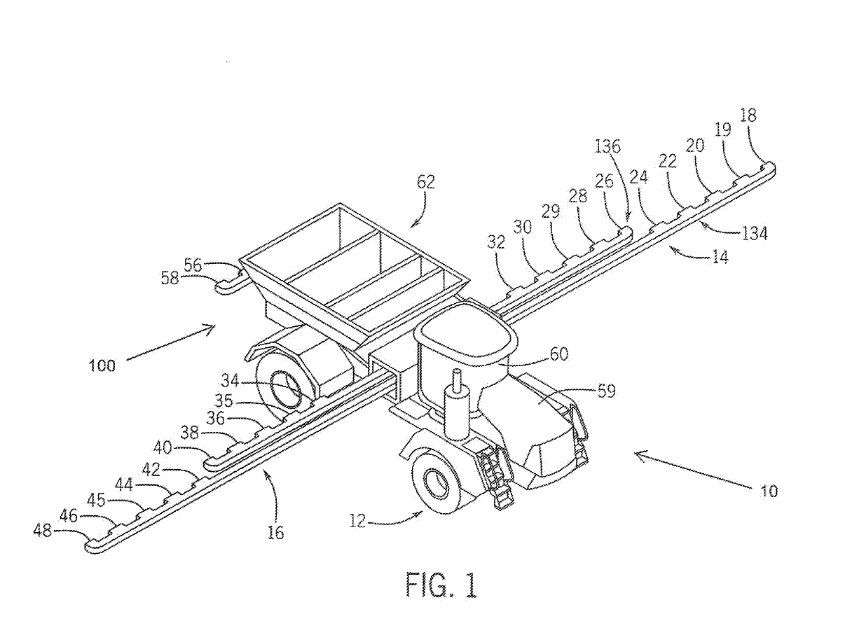

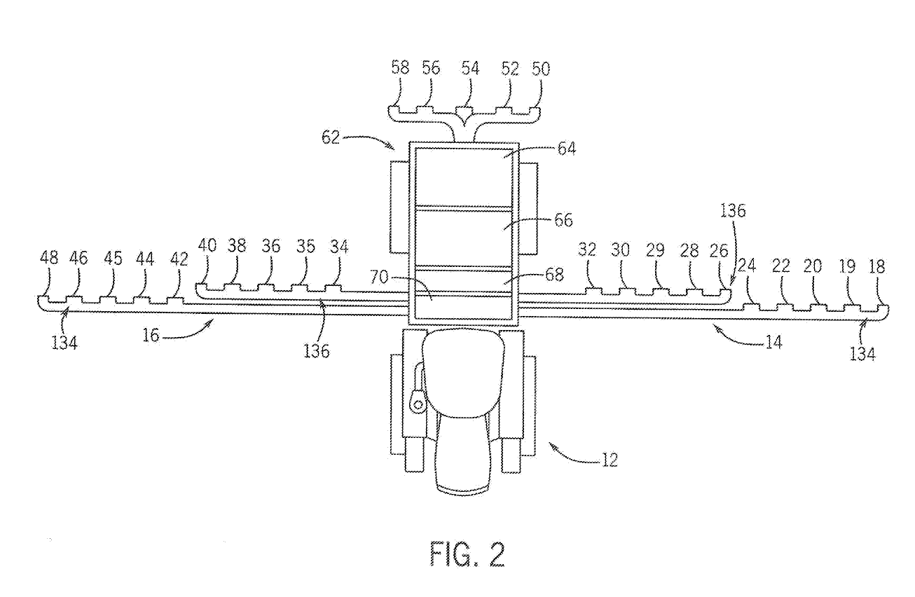

Referring now to the drawings, and more particularly to FIGS. 1-3, there is shown an agricultural application implement 10, on which a mechanical conveying system 100 can be used. In the exemplary embodiment shown, application implement 10 is a granular fertilizer applicator 10. As is known in the art, applicator 10 generally includes a large tired transport unit 12 such as truck or tractor, and laterally extending particle delivery booms 14 and 16, which may be pivoted to a stowed position close to the implement for storage or transport. Each boom 14, 16 includes a plurality of boom tubes or conduits terminating at the outboard end in a particle delivering unit, which for fertilizer applicator 10 are a spreading outlet or nozzle. In the exemplary embodiment shown, boom 14 includes ten nozzles 18, 19, 20, 22, 24, 26, 28, 29, 30 and 32; and boom 16 includes ten nozzles 34, 35, 36, 38. 40, 42, 44, 45, 46 and 48. Additionally, at the back of applicator 10 there are five rear nozzles 50, 52, 54, 56 and 58 to provide full and complete coverage across the width of implement 10, include the area between the inboard-most nozzles 32 and 34 of booms 14, 16. Implement transport unit 12 is self-propelled by an engine in an engine compartment 59 and includes an operator cab 60. In the exemplary embodiment shown, an uncovered tank. 62 includes compartments 64 and 66 for carrying particulate material to be distributed to and disbursed by nozzles 18-58. Further smaller compartments 68, 70 can be provided to supply micro-nutrients or other materials to nozzles 18-58. The supply of particulate material A-D in compartments 64, 66, 68. 70 is replenished periodically from a still larger volume supply vehicle (not shown).

Fertilizer applicator 10 is illustrative of the types of equipment for which, the mechanical conveying system 100 can be used; however, it should be understood that the mechanical conveying system 100 may, of course, be employed in conjunction with other agricultural equipment such as tillage, seeding or planting devices, and is useful in distributing particulate material other than fertilizer.

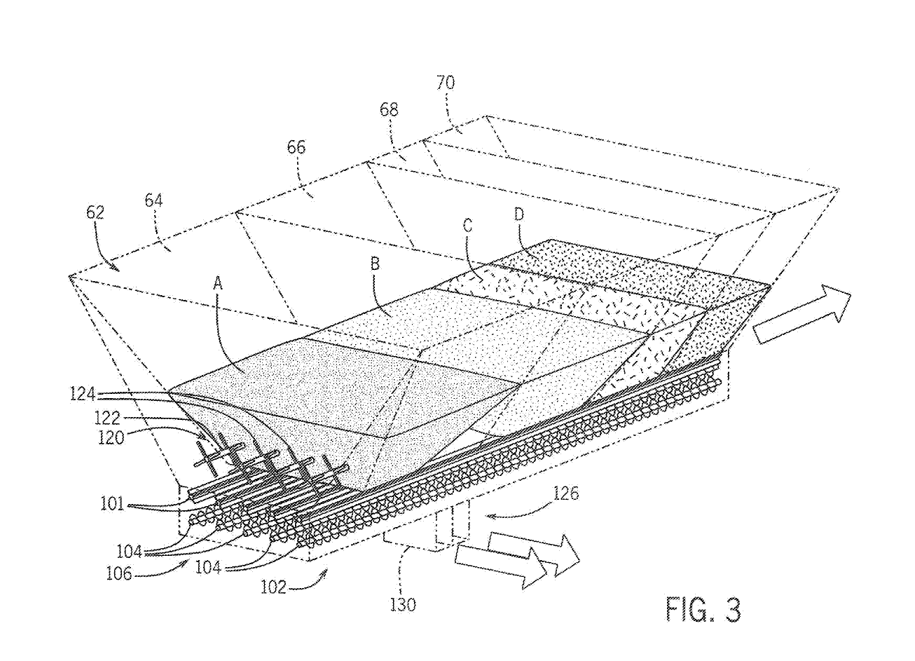

Looking now at FIGS. 3-5, in the illustrated exemplary embodiment the compartments 64-70 of the tank 62 are each disposed directly above a mechanical conveying system or assembly 100. The system 100 includes a number of mechanical conveyors 102. The compartments 64-70 each include a suitable discharge or metering mechanism 101 that enables the particulate material disposed within each of the compartments 64-70 to flow in a controlled manner through the discharge mechanism(s) 101 and into each mechanical conveyor 102.

In the exemplary illustrated embodiment, the mechanical conveyors 102 take the form of one or more augers 104 that are disposed within one or more individual transport housing(s) 106 that encircle the auger(s) 104 along their length. The housing(s) 106 in exemplary embodiments can enclose one or multiple augers 104 and can generally conform to the shape of the augers 104 disposed for rotation therein. The housing(s) 106 are open at one end 107 in order to dispense the particulate material from the housings 106 for discharge through an adjacent portion of the booms 14, 16 or the rear nozzles 50-58. The housings 106 include apertures 108-114 located in alignment with each of the discharge mechanism(s) 101 for the compartments 64-70. The apertures 108414 enable particulate material from the compartments 64-70 to enter the housings 106 through the apertures 108-114 for movement by the augers 104 to the open ends 107 of each housing 106. In certain exemplary embodiments, the discharge mechanism(s) 101 for each auger 104 can extend the length of the tank 62, or can be formed of individual modules 103 (FIG, 5) disposed in alignment with the apertures 108-114 and operated by suitable operating mechanism such as electric motors 105 associated with each module 103 and controlled from the cab 60. In alternative embodiments the one or more conveyors 102 can be formed of other suitable mechanical conveyors 102, such as one Or more conveyor belts (not shown), among others, that are disposed within complementary shaped housings 106.

In the illustrated exemplary embodiment of FIGS. 3-5, the augers 104 are each, operably engaged with a gear system 116 that in turn is connected to a motor 118. The motor 118 can be independently operated or can be operated utilizing a power take-off (not shown) from the transport unit 12. The operation of the motor 118 operates the gear mechanism 116 and causes the augers 104 to rotate within the respective housings 106. The operation of the motor 118 can be controlled to control the speed of rotation of the augers 104, either collectively or independently, such that the speed of the mechanical conveying system 100 can be varied as desired but not to meter the product(s).

Looking now at the exemplary embodiment of FIG. 3, the tank 62 can additionally include a product disturbance system 120 that is located within the compartments 64-70 of the tank 62. The product disturbance system 120 operates to disturb or agitate the particulate material held within each compartment such that the particulate material freely flows through the discharge mechanism in each compartment 64-70 and into the aligned housing 106 without premature particulate material starving into the mechanical conveying system 100. In the illustrated exemplary embodiment, the product disturbance system 120 takes the form of a number of shafts 122 extending through the compartments 64-70 of the, tank 62, with each shaft 122 having a number of splines or arms 124 extending outwardly therefrom. The splines 124 are moved through the particulate material by the rotation of the shafts 122 in order to break up any agglomeration or clumping of the particulate material within the compartments 64-70. The product disturbance system 120 can be operated using the motor 118 or a separate drive device/mechanism (not shown).

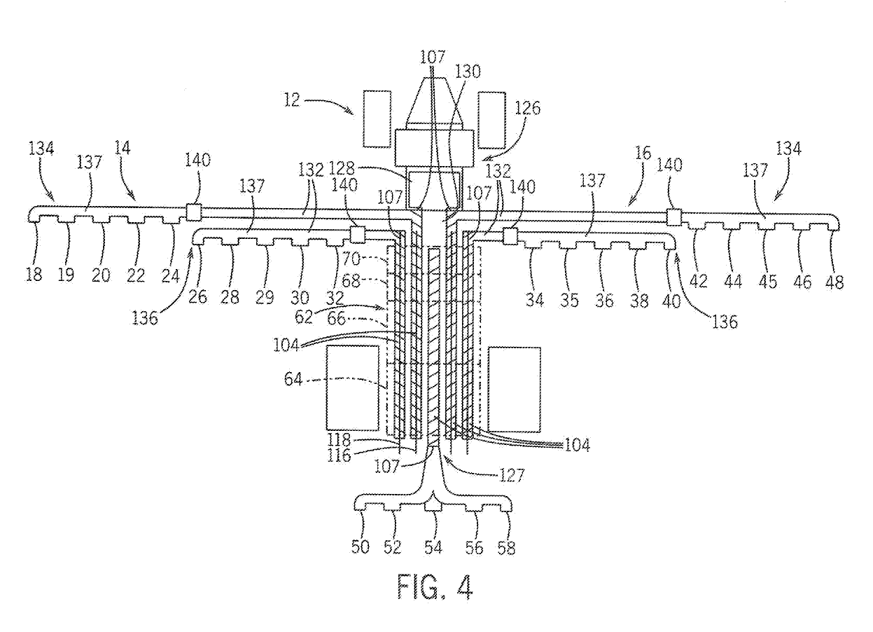

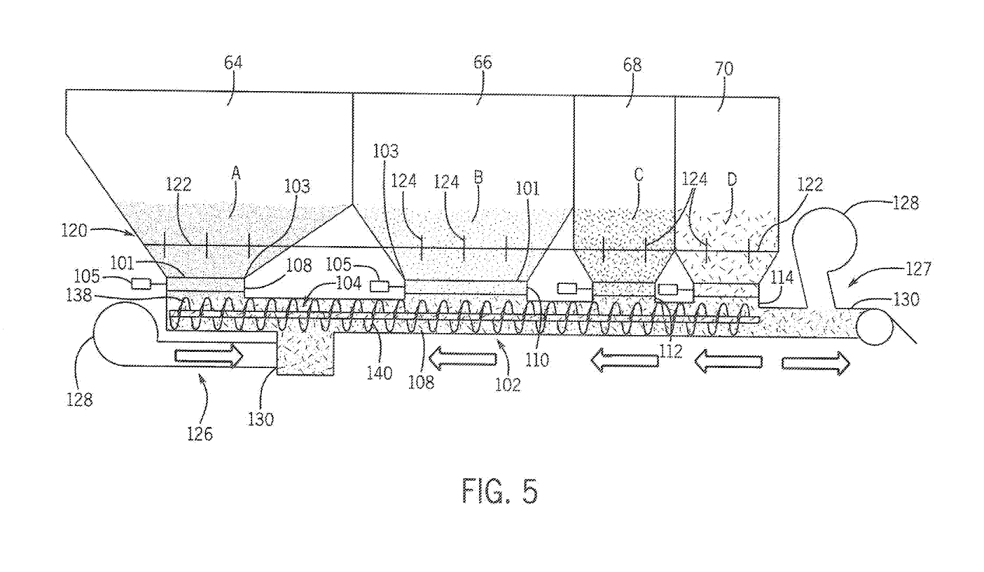

With reference now to FIGS. 4 and 5, in the illustrated exemplary embodiment the mechanical conveying system 100 includes five (5) longitudinal augers, with four (4) augers 104 running forward towards the transport unit 12, and one (1) auger 104 running rearward with regard to the transport unit 12 that collect product/particulate material from the four different compartments 64-70 within the tank 62. The central auger 104 runs with reverse fighting so it can deliver products/particulate material from the compartments 64-70 to the rear nozzles 50, 52. 54, 56, 58 while the four other augers 104 transport the product forward, and feed the nozzles 18-48 on booms 14 and 16, via particle injectors 126, 127 operably engaged with the booms 14, 16 and the rear nozzles 50-58, respectively. The particle injectors 126, 127 each include a large capacity fan 128, such as a cotton picker fan, that blows air into a plenum 130 that is connected to the open end of the respective auger(s) 104. In injector 126, in one exemplary embodiment the plenum 130 can be molded or otherwise formed from a single section or component and splits and directs the air into delivery channels 132 that are operably connected to the open ends 107 of the housings 106 for each auger 104 and extend into the forward portions 134 and rear portions 136 of the booms 14, 16. As the air exits the plenum 130, the air contacts and mixes with particulate material being ejected from the open end 107 of the housing 106 by the augers 104. The mechanical conveying system 100 uses large diameter channels 132 that in certain exemplary embodiments are between 3″-10″ in diameter, and in other exemplary embodiments are between 4.5″-5″ diameter, to move the product/particulate material out of the plenum 130 and into the booms 14, 16, which creates a smaller pressure drop than with multiple individual pipes as used in the prior art. Further, the larger channels 132 also require a reduced air flow rate in cubic feet per minute (CFM), such that the fan 128 can be operated at a lower speed, increasing the useful life of the fan 128. From each of the channels 132 the product/particulate material can be split using a suitable particle distribution mechanism 140 into multiple smaller tubes 137, which in certain exemplary embodiments are between 1.5″-4″ in diameter, and in other exemplary embodiments are between 2.5″-3″, disposed along the length of the booms 14, 16 for dispensing or spreading via the nozzles 18-48. For the rear injector 127, a smaller fan 128 can be used, as the particulate material A-D is ejected from the rear plenum 130 directly to the nozzles 50-58 to be dispensed therefrom.

Further, the orientation of the augers 104 along with the particulate material A-D within the compartments 64-70, can block, any static pressure hum the fans 128 to avoid any product metering hesitation when using non-pressurized compartments 64-70 or tanks 62, further simplifying the construction of the system 100 while maintaining a constant feed of the particulate material A-D to the system 100.

Referring now to the exemplary embodiment illustrated in FIG, 5, the booms 14, 16 are disposed more centrally on the applicator 10, as opposed to at the front of the applicator 10, as in FIG. 4. In this embodiment, the central auger 104 is flighted configured and operates in the same manner to receive, mix and move the particulate material from the compartments 64-70 to the injector 127 and rear nozzles 50-58.

However, the augers 104 disposed on opposite sides of the central auger 10 are formed with reverse fighting on a forward portion 138 to transport material from the front compartment(s) 64 in a rearward direction to the particle injector 126 and a rearward portion 140 having regular fighting to transport material from the rear compartments 66-70 in a forward direction to the particle injectors 126. As the fighting on the forward portion 138 and on the rearward portion 140 are opposed, as the motor 118 drives the gear mechanism 116 connected to the multiple augers 104, rotation of the forward portion 138 and the rearward portion 140 drives the particulate material from each of the compartments 64-70 towards the particle injector 126 for dispensing the particulate material via the booms 14, 16.

The configuration of the augers 104 enables the particulate material from each compartment 64-70 to be metered using one or both of the discharge mechanism on each compartment 64-70 and the rotational speed of the auger(s) 104. In this manner, the rate of dispensing the particulate material from the forward portions 134 and rear portions 136 of the booms 14, 16 can be varied simply by altering the rotational speed of the associated auger 104 to allow for sectional control and/or turning compensation without the need for any additional electrical and/or mechanical metering system or device. Further, the augers 104 effectively mix the particulate material from the various compartments prior to reaching the particle injector 126,127, which provides additional mixing to the particulate material prior to discharge from the nozzles 18-58.

Further, similarly to the embodiment of FIG. 4, in FIG. 5 the augers 104 can be replaced by belt conveyors (not shown) with a belt conveyor taking the place of each forward portion 138 and each rearward portion 140 to move the product/particulate material centrally to the injector 126 for the booms 14, 16 and one conveyor belt replacing the auger 104 for moving he particulate matter toward the rear nozzles 50-58.

While the mechanical conveying system 100 disclosed so far herein have been primarily with respect to mechanical fertilizer application equipment or applicator commonly referred to as a “floater”, it should be understood that the advantages from the mechanical conveying system 100 disclosed herein can be obtained on other types of equipment for applying particulate materials in a field. Planters of various types are known to include an applicator unit, such as a drill or seeder, and may, include an air cart having one or more bulk tanks carrying fertilizer and/or seeds to be planted. The mechanical conveying system 100 disclosed herein can be provided on the planter, and one or more inductor on the air cart. If the air cart is then used with a planter of a different type, or with another type of particle application equipment, adjustments to the mechanical conveying system 100 can be made without the need to adjust the inductor assembly on the air cart. Accordingly, switching from one crop to another crop or from one planter to another planter does not require major adjustment of the inductor assembly on the air cart.

In using a mechanical conveying system 100 as disclosed herein, a variety of materials can be applied by a variety of different implements. The particulate material to be applied is contained in one or more compartments. The particulate material or materials are supplied from the tanks to the mechanical conveying system 100 wherein the material or materials are conveyed to one or more particle injectors, while being intermixed with one another. At the particle injector the conveyed product or products are provided in a metered flow and transferred to one or more particle delivery unit, which can be a broadcast spreader, seeder for depositing seeds or other materials across the surface of soil, a row opener unit for depositing seeds or other material in rows, or the like.

Various other alternatives arc contemplated as being within the scope of the following claims particularly pointing out and distinctly claiming the subject matter regarded as the invention.

We claim:

1. An agricultural product delivery system, comprising:
at least one particulate material supply compartment;
at least one particle delivery unit for applying particulate material from the at least one supply compartment;
a mechanical conveying system providing a mixed and metered flow of particulate material from the at least one particulate material supply compartment to the at least one particle delivery unit; and
a metering system connected between the at least one particulate supply compartment and the mechanical conveying system.

2. The agricultural product delivery system of claim 1 wherein the mechanical conveying system does not include a separate metering device.

3. The agricultural product delivery system of claim 1, wherein the mechanical conveying system includes one, or more augers,

4. The agricultural product delivery system of claim 3, wherein the mechanical conveying system includes at least two augers, the two augers flighted oppositely from one another.

5. The agricultural product delivery system of claim 4, wherein at least one of the augers includes a forward portion and a rearward portion, and wherein the forward portion and the rearward portion are flighted oppositely from one another.

6. The agricultural product delivery system of claim 3, wherein the at least one particulate material supply compartment is a plurality of supply compartments, and wherein the one or more augers are in communication with each of the plurality of supply compartments.

7. The agricultural product delivery system of claim 3, including a motor operably connected to the one or more augers to independently control the rotation of each of the one or more augers.

8. The agricultural product delivery system of claim 7, further comprising a gear mechanism interposed between the motor and the one or more augers.

9. The agricultural product delivery system, of claim 3, further comprising a housing disposed around each of the one or more augers and having an open end.

10. The agricultural product delivery system of claim 9, farther comprising a number of housings disposed around each of the one or more augers,

11. The agricultural product delivery system of claim 10, further comprising a number of delivery channels operably connected to the open end of each of the number of housings,

12. The agricultural product delivery system of claim 11, including at least one injector disposed between the open ends of the housings and the delivery channels.

13. A method of delivering a number of agricultural products from a number of compartment containing the number of products to a particle delivering unit applying the, particles in a field, comprising: supplying the number of agricultural products from the number of compartments to a mechanical conveying system; mixing the agricultural product in the mechanical conveying system to form a mixed product; conveying the mixed product to the particle delivering unit; metering the mixed product within the mechanical conveying system; and applying the mixed product in an agricultural field.

14. The method of claim 13, wherein the mechanical conveying system does not include a separate metering device.

15. The method of claim 13, wherein the step of metering the mixed product comprises altering the speed of rotation of the mechanical conveying system.

16. The method of claim 13 wherein the mechanical conveying system comprises a number of augers and wherein the step of metering the mixed product comprises altering the speed of one or more of the augers.

17. The method of claim 16 wherein the step of altering the speed of one or more of the augers comprises independently altering the speed of one or more of the augers.
